(19) United States
(12) Patent Application Publication
(10) Pub. No.: US 2007/0074258 A1
(43) Pub. Date: Mar. 29, 2007

(54) Data collection and analysis for internet protocol television subscriber activity

(75) Inventors: Catherine Alexandra Wood, Chicago, IL (US); Anthony Joseph Reynolds, Oak Lawn, IL (US); Daniel Patrick Malee, Chicago, IL (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/230,590

(22) Filed: Sep. 20, 2005

(51) Int. Cl. H04N 7/173

(52) U.S. Cl. 725/105

(57) ABSTRACT

A method and apparatus are provided that interact with an IPTV product deployed in a communication network. The method and apparatus of the present invention collects subscriber activity data, such as channel changes generated by the subscriber while watching video or TV in an IPTV system. The system and method of the present invention collects, parses and processes this consumer activity data. The method and apparatus of the present invention collects and aggregates the IPTV consumer activity data from multiple IPTV consumer activity data collection systems. The aggregated data, collected over a national or global basis can then be used to generate metrics. The metrics are then analyzed by business rules to generate marketing data reports that can be used as an strategic analysis tool for communication network operators, content providers and advertisers to determine consumer usage of the IPTV systems and viewing of programming and advertising.

### BACKGROUND OF THE INVENTION

1. Field of the Invention

The present invention relates to the field of electronic monitoring of an internet protocol television (IPTV) system and more specifically to a monitoring subscriber activity and usage of the of IPTV system.

2. Description of the Related Art

Tracking, monitoring and analyzing which TV/cable channels people are watching at home on a large scale is extremely important to the ratings of TV programs offered by broadcasting/cable networks. The rating data such as that from Nielsen Media Research is so valuable that almost all major players in the television industry spend tens of millions of dollars to purchase the Nielsen TV rating data. The Nielsen data in turn directly influences how billions of advertising dollars are spent each year in the U.S. market. Tracking, however, of such viewing data involving thousands of households throughout the U.S. is an expensive and problematic process. For example, the Nielsen rating system, the de facto national measurement standard service for the television industry, uses a people-based “meter” installed in 5,000 or so “Nielsen's households” randomly selected from 99 million households in the U.S. that have at least one person watching TV. The Nielsen data is collected in 15-minute intervals are based on a paper diary system invented in the 1960s. It is widely acknowledged that such a manual process is not only error prone but also inadequate to track people's television viewing habits in today's Internet/channel surfing era. Nielsen analyses is based on a small select group of consumers handpicked by Nielsen itself.

With the arrival of Internet Protocol (IP) based TV (IPTV) services installations at tens of millions of households in the U.S. over the next decade, there are new alternatives to automatically track which TV programs are being watched at an IPTV household. Servers within a communication network in which IPTV systems are provided can monitor content that is broadcast to set top boxes (STBs) in homes and businesses across the country. The set top boxes, which may include computer processors or other intelligent devices, are generally connected to television sets or computer monitors, where the broadcast content is displayed. IPTV provides video and live TV content to the consumers through the communication network. IPTV provision and monitoring systems are generally deployed on a regional level in a communication network. Each IPTV instance is deployed in a particular geographic region independently of other IPTV instance in another geographic region. Thus, there is a need for a consumer activity monitoring system that aggregates and analyses the data from individual IPTV regions.

### SUMMARY OF THE INVENTION

In one aspect of the invention a method and apparatus are provided that interact with an IPTV product deployed in a communication network. The method and apparatus of the present invention collects subscriber activity data, such as channel changes generated by the subscriber while watching video or TV in an IPTV system. The system and method of the present invention collects, parses and processes this consumer activity data. Substantially all subscriber activity data is captured by the present invention. The method and apparatus of the present invention collects and aggregates the IPTV consumer activity data from multiple IPTV consumer activity data collection systems. The aggregated data, collected over a national or global basis can then be used to generate metrics. The metrics are then analyzed by business rules to generate marketing data reports that can be used as an strategic analysis tool for communication network operators, content providers and advertisers to determine consumer usage of the IPTV systems and viewing of programming and advertising.

In another aspect of the present invention a method and apparatus are provided that collect the data from IPTV systems across the nation, and transform the data into a useable format. This will allows content providers and advertisers to use the subscriber activity data collected from multiple IPTV systems to determine IPTV viewing patterns and habits. The present invention provides content providers and advertisers with a much more comprehensive data collection, and eliminates some of the obvious skewing of the data that prior viewer activity monitoring systems such as Nielsen's small sample created during data analysis. Thus with the large data sample base of the present invention, having virtually millions of data samples, collected and archived periodically (e.g., hourly or in real-time) for a period of years for millions of subscribers, a small perturbation of a single or a few percentage points in subscriber activity data trends is indicative of a trend change in subscriber activity rather than attributable to a statistical aberration of a smaller data sample.

The present invention provides business rules for analysis of subscriber activity data metrics. The business rules provide analysis to content providers, which gives them a better understanding of their viewer's acceptance of content and advertising. Data is collected on a per household or account level therein enabling correlation and analysis of viewer demographic and activity based on subscriber account information. The present invention also monitors virtually all of activities associated with an IPTV subscriber account including but not limited to remote control (RC), set top box (STB), digital video recorder (DVR) and remote desktop protocol (RDP) operations at the subscriber house hold associated with a particular residential gateway (RG). Sub account user identification can also be supported for identifying activity for individual users under a subscriber account within a household (children, teen, adult, male, female, etc.)

In another aspect of the invention a system and method are provided for analyzing consumer activity data from an IPTV system comprising collecting subscriber usage data in a load-ready data format from a plurality of IPTV systems and storing the collected subscriber usage data in a data base such as a data warehouse. The system and method of the present invention further aggregate the subscriber usage data into subscriber events. The subscriber events can comprise but are not limited to channel tune, set top box power up/down, video on demand purchase, trick mode, digital video recorder (DVR) record and DVR delete.

The system and method of the present invention correlates subscriber's usage of content and advertising based on at least one of the set consisting of demographic sector, time slot and geographic region. The system and method of the present invention provides data provide business rules that enable analysis of a demographic sector for acceptance of applications, content and advertising. The present invention performs metrics on subscriber events comprising but not limited to: viewing usage, simultaneous DVR recording and watching usage, channel changes, recorded channels and show, VOD replay, preview generated purchased events, remote desktop protocol applications per sitting, VOD DVR recordings, scheduled DVR recordings, channel viewing time and average RDP time. The metrics are analyzed by applying a set of business rules to determine viewership trends and to guide content providers and advertisers as to viewer response and appropriate placement of content and advertisement to optimize viewer response.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 is a schematic diagram depicting a communication network employing multiple IPTV instances in accordance with one embodiment of the present invention;

FIG. 2 is a flowchart depicting a method for collecting IPTV consumer activity data; and

FIG. 3 is a flowchart depicting a method for analyzing IPTV consumer activity data.

### DETAILED DESCRIPTION OF THE INVENTION

In view of the above, the present invention through one or more of its various aspects and/or embodiments is presented to provide one or more advantages, such as those noted below.

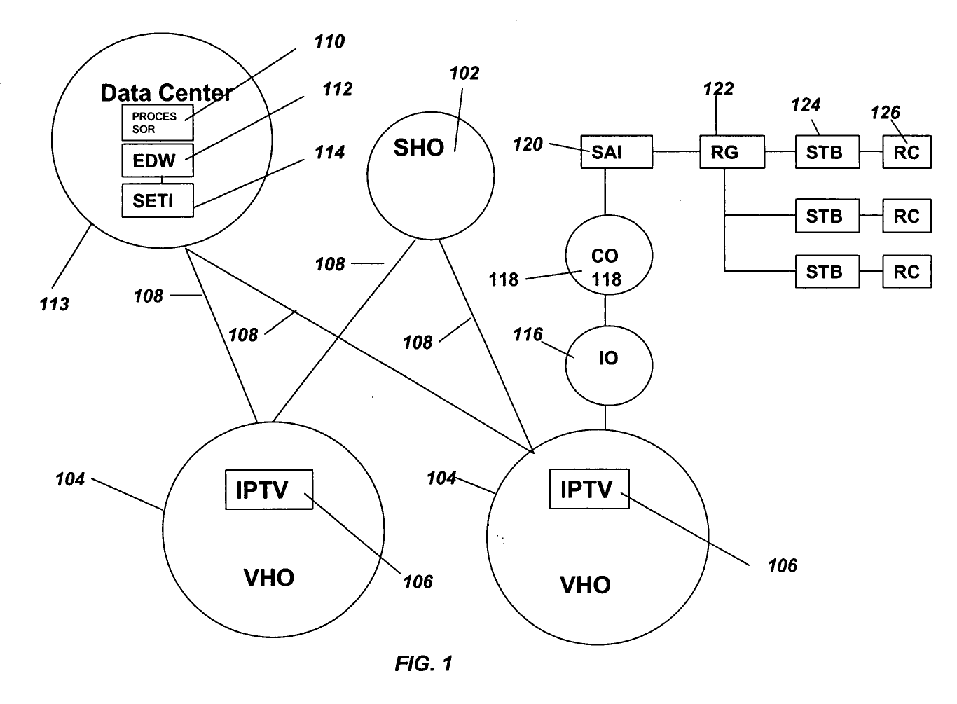

FIG. 1 is a schematic diagram depicting a communication network employing multiple IPTV instances in accordance with one embodiment of the present invention. As shown in FIG. 1, the communication network is comprised of the following major elements: Super hub office (SHO) 102 for acquisition and encoding of video content; Video hub office (VHO) 104 in each demographic market area (DMA); an Intermediate office (IO) 116 and Central office (CO) 118 locations in each metropolitan area; the access network between central office and multiple or single dwelling living units; and the in-home network with residential gateway (RG) 122. The SHO and VHO communicate view high speed digital communication lines 108.

The video delivery subsystem is broken down into the following two distinct tiers: the SHO distributes content to the VHOs which are spread across the United States. The SHO is in a central location for acquisition and aggregation of national-level broadcast TV (or linear) programming. A redundant SHO may be provided for backup in case of failure. The SHO is also the central point of on-demand content insertion into the communication network. Linear programming is received at the SHO via satellite and processed for delivery to the VHOs via satellite. On demand content is received from various sources and processed/encoded to codec and bit-rate requirements for the communication network for transmission to the VHOs over high speed communication link 108. The VHOs receive national content from the SHO. The VHOs are the video distribution points within each DMA. All application systems, regional subscriber database systems, VOD servers, and fast channel-change servers (D-Servers) are located in the VHO. At least one IPTV instance 106 is placed at each VHO. Traffic from VHOs is distributed towards the subscriber first via the intermediate offices (IOs). The COs are connected to the IOs to further distribute traffic towards the subscribers. Traffic reaches the subscribers residential gateway (RG) 122 at least partially via either fiber to the node (FTTN) or fiber to the premises (FTTP). FTTN equipment, located at a serving area interface (SAI), is connected to the CO. FTTN equipment may also be located in the CO. Toward the subscriber household, a network interface device (NID) and RG 122 with a built-in VDSL modem or optical network termination (ONT) comprise the customer premise equipment (CPE). In both cases the RG is connected to the rest of the home STBs 124 via an internal network such as an Ethernet. Each STB has an associated remote control (RC) 126 which provide data entry to the STB to control the IPTV selections from the IPTV system 106.

Subscriber activity data comprising IPTV selection and control inputs and data entry is collected from each household RG for all STBs in the household transmitted from each household RG to an IPTV instance at the VHO. The data may be collected and transmitted from the RG to the IPTV in real time or on a periodic schedule. A separate IPTV instance runs on a processor in each VHO. The IPTV instance platform 106 or processor may be a Sun Microsystems computer. The subscriber activity data is collected periodically or in real-time from each RG and transmitted to the ITPV instance in the VHO. In the current example of the invention, a mass storage electronic data warehouse (EDW) 112 is placed in secure Data Center 113. A Data Center is a internal location within a secured firewall. EDW 112 may be a commercial database such as provided by Oracle running on a Sun Microsystems processor. Other processors and database systems are suitable for use with the present invention as well.

EDW comprises a processor and data storage medium that provides mass storage of the subscriber activity data. A SETI (Subscriber Event Transmission Interface) application processor 114 associated with EDW runs in a processor at the Data Center. SETI periodically collects the subscriber activity data from each VHO. SETI may also operation in real time to collect the data from the VHOs. The subscriber activity data from each VHO is pulled by the SETI periodically or can be collected in real time and relayed to SETI. Real time data collection enables real time data analysis for dynamic management of content and advertising at the VHO. A processor performs parsing, aggregation and metrics on the consumer activity data stored on EDW. The processor also runs business rules on the metrics. The business rules are stored in the EDW.

The set top box 124 may also provide the content, or a portion of the content, to a display device such as a television set, IPTV television set, computer monitor, projection television device, audio-only stereo system or loudspeaker, or other display device. The display device may be associated with a Telephone Number (TN). It will be appreciated that the set top box and the display device may be combined into an integrated device, such as a computer system, or may be distinct devices.

A remote control (RC) 126 and antenna that can transmit an electronically detectable signal to the STB 124. The STB may be coupled to a television set, a computer, or other display device that is capable of displaying or playing the content, including the audio content. Since the content contains the audio component and/or the additional audio content, the display device may present or play the audio component, including the additional audio content. The content may be delivered to the display device using traditional video delivery techniques, such as coaxial cables and/or S-video cables, or may be delivered wirelessly, using WiFi, Bluetooth, or other video delivery techniques.

The STB 124 may forward the consumer remote control activity selections to the RG which in turn sends the data to IPTV instance 106 via the defined communication path between the VHO and the associate RG. Substantially all consumer remote control activity is recorded and sent to the IPTV instance at the VHO.

The SHO processor 110 may be implemented as a Sun Microsystems computer. The STB contains a single microprocessor and memory, or may be implemented as multiple microprocessors and memories located at a single location or at several locations. A downstream signal from the IPTV network to the display device includes content for display on the display device, and an upstream signal from the display device to the IPTV network instance (via the remote control) includes consumer activity data comprising channel selections and any other input from the RC.

The IPTV data selections are collected from multiple IPTV instances from VHOs nation wide and stored in an electronic data warehouse (EDW). EDW archives subscriber activity data collected nationally so that metrics can be run on the aggregate data and business rules applied to the metrics to examine consumer activity. Consumer activity can be compared from region to region (New York and California), between time frames (how many people watched a particular show on a given date and time versus another date and time, and how separate demographic sectors (ages 9-12 versus 18-35) react to different programming and advertising.

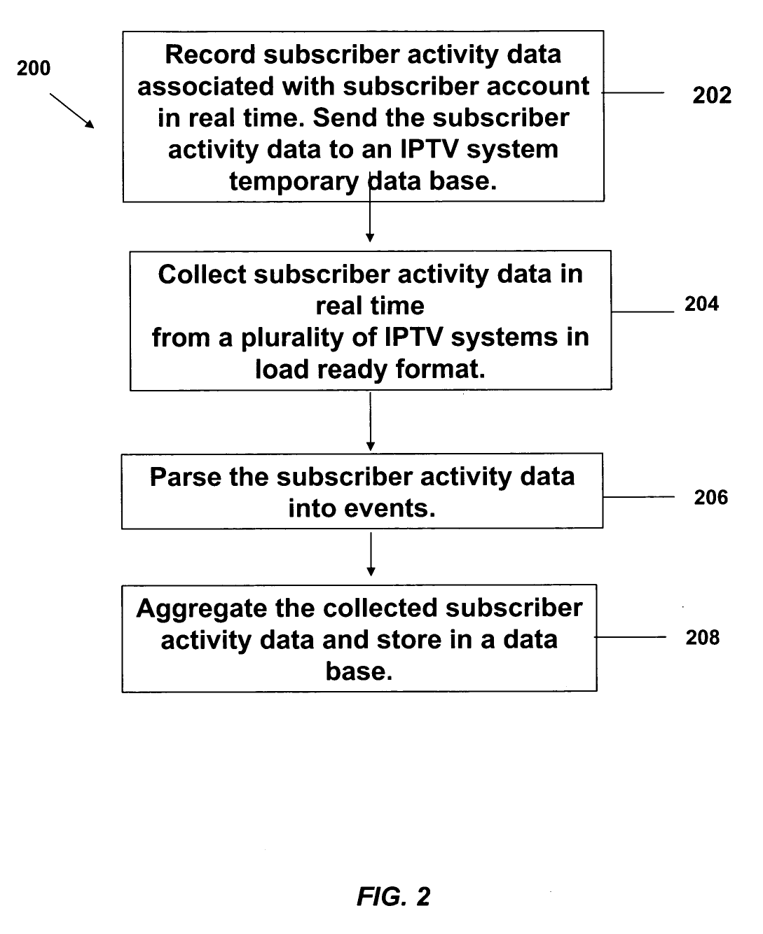

FIG. 2 is a flowchart 200 depicting a method for recording, sending, aggregating and parsing consumer activity data on a national level, in accordance with one embodiment of the present invention. A shown in 202 the present invention records subscriber activity data associated with a subscriber account. The collected subscriber activity data at a particular house hold is merged for the subscriber account and sent to the IPTV instance at the VHO. The IPTV instance stores the received subscriber activity data in a temporary database where the data is staged for transmission to the EDW. As shown in block 204 the present invention collects subscriber activity data periodically or in real time from numerous IPTV instances at various VHOs.

Subscriber activity data may include viewing content such as a movie, television program, advertising or other video and/or audio content received from a control center of a broadcasting company. Virtually all subscriber activity data associated with the IPTV STBs for a particular RG or household is collected, aggregated, parsed and stored in the EDW for metrics and business rule analysis.

SETI 114 captures subscriber activity data from the IPTV instance and passes it on to EDW. As there is no direct communication among IPTV instances at different VHO's, IPTV instances at separate VHO's are unaware of other instances. That is, each IPTV instance has an independent subscriber activity data base. Each IPTV subscriber account is identified by a unique ID. Thus, account demographic information for an account such as age, sex, race, geographic location, education, income and other information is available for correlating demographic data with subscriber activity.

The processor 110 performs data loading to the EDW from the IPTV instances from the VHO's into its data warehouse. The data warehouse may be a mass storage facility such as that provided commercially. The present invention, using the EDW subscriber activity data, performs metrics and aggregations on the subscriber activity data. A set of programmable business rules stored on EDW are used to analyze the metrics.

After the data is sent to EDW in the specified load ready format from SETI, the IPTV instance at the VHO is no longer responsible for it. Subsequent analysis/mapping is performed at the EDW warehouse. In the event of perceiving having bad quality data, data might be requested again and sent from SETI. An example of a suitable IPTV instance is Microsoft's IPTV product. Microsoft's out of the box (OOTB) usage/activity events are captured by IPTV platform. Additional user activity data related to set top box activity can also be sensed by monitoring devices in the communication network associated with the IPTV system. These activities can also be monitored and stored in the EDW data warehouse.

There is no initial load of data from SETI to EDW. As the subscriber usage data is loaded progressively. Both client device information and external Id is available within IPTV system (within a subscriber management system (SubscriberDB)—obtained as part of the IPTV account provisioning). SETI has access to a short lived temporary database containing activity logging data and DeviceID/externalID correlation data for bulk transfer (through DTS) to the SETI's staging DBs.

IPTV has an activity logging system that tracks user events on the STB. The following is an example, not intended to be exhaustive of six types of subscriber activity data events passed through to SETI. 114 SETIpulls and formats the event activities into a load-ready format from the IPTV instances for EDW, and passes it to EDW as a daily batch process. In an alternative embodiment, SETI receives the data in real time as it is pushed from each IPTV instance temporary data base in real time.

The following are examples of six event types will be logged along with time stamps: Channel tune, Box power up/down, VOD purchase, Trick Mode, DVR action Record and DVR action Delete. For each of the EDW destination tables, unique files will be created each time a push from SETI to EDW happens. The six examples are not intended to be limiting as substantially all subscriber activity associated with an IPTV account is monitored and reported to the IPTV system. EDW requests additional subscriber activity from the IPTV log or events based on direct monitoring of the consumer STB in the associated communication network in which the IPTV platform resides.

The following algorithms are related to the tasks listed in the data transformation service (DTS) Work Flow: Create TempCustomer Table performs Simple SQL statement to create the table with the correct columns and types. Create Temp Logging Table performs Simple SQL statement to create the table with the correct columns and types. Create Index on TempLogging Table adds an index on EventID, OriginTime and Client ID in the TempLogging Table.

The core process runs in a loop to cover all VHO's and all subscriber accounts at each of the VHO's as follows: Start Loop; Get Data set from VHOID Table will all valid VHOIDs; Get Next VHOID; Select next VHOID; If no more VHOIDs, revert back to original process flow. With the previously determined VHOID, the present invention fetches the corresponding connection string, username and password from VHOID table and sets connection properties to values pulled from table along with table designation of SMS. With the previously determined VHOID, the present invention fetches the corresponding connection string, username and password from a VHOID table. The present invention then sets connection properties to values pulled from table along with table designation of SubscriberActivity.

The present invention then creates a DTSRunID for identification purposes. The present invention then determines which table within IPTV is currently active (being written to). The present invention then transfers all Subscriber Activity Data that is in the non-active tables. The present invention then updates the DTSRun information, and includes the DTSRunID into the TempLogging tables, identifying for each row where the data came from. The present invention then deletes the data pulled from IPTV. The present invention pushes data on the STB and the Account into a TempCustomer Table along with the current DTS ID.

The present invention then fetches all distinct DeviceID, OriginTime, and corresponding Customer ID where Event Type equals Channel Tune. For each Distinct DeviceID and OriginTime, the present invention loops through the corresponding rows to get all related attributes. Once all attributes are retrieved, insert into Channel Tune Table along with CustomerID.

The present invention pushes data into Power State Event Table. The present invention fetches all distinct DeviceID, OriginTime, and corresponding Customer ID where Event Type equals Power State. For each Distinct DeviceID and OriginTime, loop through the corresponding rows to get all related attributes. Once all attributes are retrieved, the present invention inserts the attributes into Power State Table along with CustomerID

The present invention perform a push into Trick Mode Event Table as follows. The present invention fetches all distinct DeviceID, OriginTime, and corresponding Customer ID where Event Type equals Trick Mode. For each Distinct DeviceID and OriginTime, loop through the corresponding rows to get all related attributes. Once all attributes are retrieved, insert into Trick Mode Table along with CustomerID.

The present invention performs a push into VOD Purchase Event Table as follows. The present invention fetches all distinct DeviceID, OriginTime, and corresponding Customer ID where Event Type equals VOD Purchase. For each Distinct DeviceID and OriginTime, loop through the corresponding rows to get all related attributes. Once all attributes are retrieved, insert into VOD Purchase Table along with CustomerID.

The present invention performs a push into DVR Events Event Table as follows. The present invention fetches all distinct DeviceID, OriginTime, and corresponding Customer ID where Event Type equals DVR Start, DVR Stop, DVR Schedule, and DVR Delete. For each Distinct DeviceID and OriginTime, loop through the corresponding rows to get all related attributes. Once all attributes are retrieved, insert relevant attributes into Stored Content Event Table along with CustomerID and inserts other attributes into Content Storage Table.

Data conversion is performed when the process worker kicks in and fetches the first data set from the staging database. At this point, the process loops through the data records one by one and for each data field associated to the data type in question (i.e. Events), the field is converted to its corresponding string representation. The converted string is then appended to a string that holds the full detail record which is the result of the database data record. The detail record string is then sent to the EDW load ready file writer component.

File creation uses the EDW Load Ready file writer component encapsulated in a file writer object, which is the central core for the creation of files. When the worker or task of the present invention creates the empty physical file on disk, it first calls a function in the file writer object to write the header record. The file writer then receives a series of detail records from the worker, appends the detail record bodies to the detail record identifier and appends them to the file in question. Upon completion, the worker invokes a file writer function to write the trailer record. The job of the file writer is to assure that the resulting file is in fact EDW load ready (i.e. header, detail and trailer records are correct).

Scalability at the level of the SETI Process is achieved by allowing the SETI Process to handle one or more Staging databases on its own as well as collaborating with multiple other IS Processes to process data from a single staging database. Case of one process handling one or more staging databases: When the scheduler determines it's time to run the process, one thread per type of data is spawned to handle this type of data. (Types of data are ChannelTune, BoxPower, TrickMode, VODPurchase, ContentStorageEventData and StoredContentData). The thread runs a job that will connect to database, fetch data, convert data, write files and send files once per staging database assigned to the process (refer to configuration file). This is the simplest data processing scenario.

In the case of multiple processes collaborating to handle one staging database, the scheduler runs the processing threads. Within each thread of the process, the process determines whether it is the leader of the process group (The leader is determined by the process with highest instance ID value). Two scenarios may occur. If the process is not the leader, the thread waits until its process is assigned the job chunk from the leader via the collaboration interface. When this happens, each data type processing thread resumes operation on the task it was assigned. If the thread waits for too long (configurable timeout), the thread with the next highest instance ID assumes the role of leader by broadcasting to its process group this decision. This broadcast needs to be acknowledged by all group members for the new leader to continue operation.

If the process is the leader, it pings all processes in its group and confirm each process's existence. Once done, the leader will connect to the staging database and compute job chunks for each of the peer processes. When done, the leader assigns the respective jobs to the processes via the remote collaboration interface and follows through to processing its own chunk.

Each thread keeps a list of status variables and logs operation checkpoints to a file located in a directory specified in the configuration file. It will also be logged in the Windows Event Viewer. At this stage, no control mechanism is provided to control the threads since threads are expected to finish their task fully after being started. Anything that hinders a thread's smooth operation (i.e. exceptions) will automatically shut the thread down and log the corresponding errors to the log file. The logs on the other hand will be available for support personnel.

All jobs that are started, stopped, failed are logged in the database and this data will be available within SETI. Data is transferred from IPTV databases directly into the SETI's staging databases via a DTS bulk transfer. The DTS Package will run over a secure connection. Both SETI and EDW reside within secure Data Center 113, so the connection between them will be secure. SETI process sends files to EDW via FTP over an internal non-public network within a firewall.

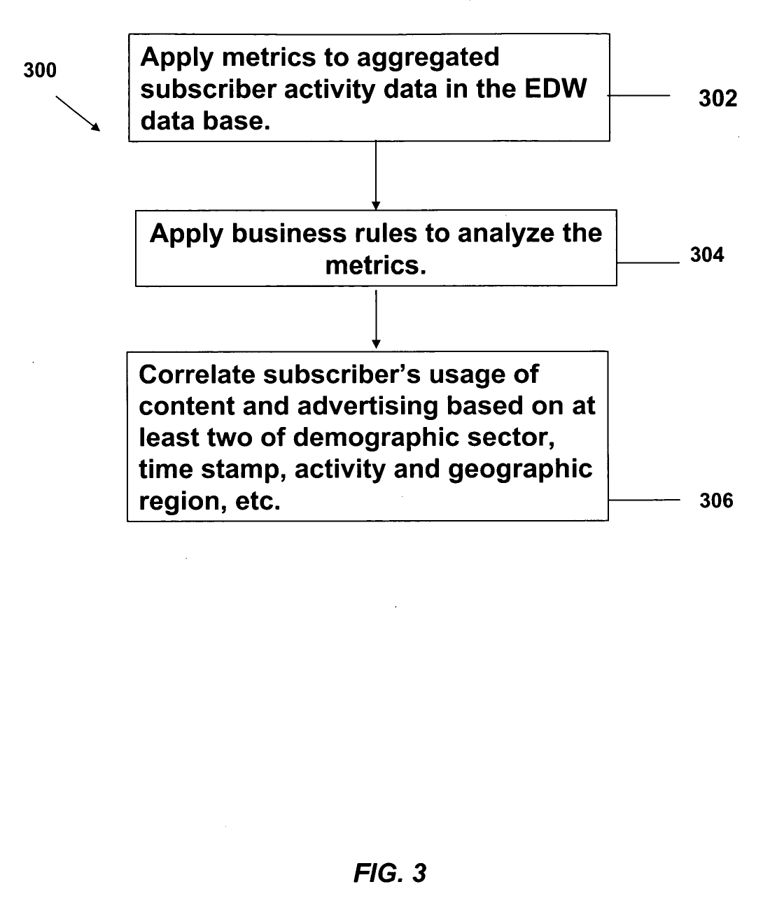

Turning now to FIG. 3, a flow chart 300 is illustrated showing how the present invention applies metrics to the data. The present invention also applies business rules to the metrics. As shown in block 302, the present invention applies metrics to the aggregated subscriber data in EDW database. Examples of these metrics are discussed below. The example metrics are not intended to limit the scope of the invention but are exemplary only. Additional metrics, limited only by the imagination and desire of the programmer can be applied to the subscriber activity data in EDW.

As shown in block 304, the present invention then applies business rules to analyze the metrics. The business rules and metrics are stored in EDW. As shown in block 306, the present invention correlates subscriber activity data for usage of content, advertising, RDP applications, etc. with demographic sectors, subscriber activities, time stamps and geographic regions. These business rule correlations are intended to be exemplary only and are not intended to limit correlations of the data. Additional correlations and business rules are appropriate for use with the present invention.

The subscriber activity data stored in EDW is in raw form having tags or tokens and time stamps indicating what actions the subscriber has taken and what time the action was taken. Essentially all subscriber actions are recorded in real time and stored in the STB and sent to the IPTV instance at the VHO either periodically or in real time. The actions may be, for example, but are not limited to, channel tune, DVR record and RDP product purchase. The subscriber actions can then be correlated with broadcast content and subscriber demographic data to determine if subscribers and which subscribers are watching or changing the channel during a particular show or advertisement. Demographic data is available for each subscriber account which may include subscriber sub identifiers for members of a subscriber household.

The raw data collected at the STB comprises the subscriber activities and is tagged to identify the type of action, subscriber account and time of action. Further demographic visibility can be provided by tagging subscriber activities with account identifier, STB identifier and sub account user identifier to indicate additional demographic data for the viewer performing the subscriber activity. This is helpful when several users are under a single account. Subscriber activity can be recorded and tagged simultaneously for multiple STBs and multiple users in a single household associated with a particular RG. The data for each subscriber is merged and passed to the IPTV instance. SETI pulls the data from each IPTV instance at each VHO periodically. The data from each IPTV instance can be sent or pushed from the RG in real time to SETI for storage in EDW. The raw data from each STB is then parsed by event and aggregated (for example, by event) at EDW so that all data for a particular event is aggregated and related in EDW database. The related demographic data is stored in the data base and remains associated with the event and subscriber activity data so that further queries and correlations are possible based on demographic data. Essentially all STBs, RGs and subscribers (users) associated with a given VHO or IPTV instance within a VHO are tracked for subscriber activity. A partial data sample of STB associated with a given VHO can also be taken so that only STBs tuned to a particular program (e.g., the Superbowl®) engaged in a particular activity (e.g., RDP application) such as a mass participation game. EDW database can be a commercial mass storage data base such as that offered by Oracle®. EDW database runs on a Sun Microsystems processor and uses mass storage media commercially available and well known in the art. Metrics are performed on EDW database. Business rules are then applied to the metrics to indicate subscribe activity trends and to evaluate content and advertising effectiveness.

Some of the metrics are discussed now as an example of metrics that may be performed on the aggregated EDW data. The example metrics are not intended to be a complete list of metrics as virtually all subscriber activities are recorded and can be aggregated and subjected to metrics.

In an exemplary embodiment a first metric comprises a viewing usage metric. The viewing usage metric measures the number of set top boxes tuned to a particular program for a period of time, for example, at least five minutes. Viewing usage measures the number of set top boxes tuned into a particular channel for a programmable period of time, for example, at least 5 minutes. The present invention enables a user to employ metrics view the viewer usage metric values in real time or for a fixed time period, such as by the half hour. The subscriber activity data indicated viewer usage data which is stored in time period slots or buckets. Time buckets can be broken up into programmable time slots, such as per half hour. For example, half-hour buckets, for 6 am to 6 pm, 6 pm to 6 am, etc. can be based on the time zone of the user. Viewer usage uses a Weighted Average for all aggregations and a standard calendar for time based aggregations.

The viewer usage data can be supplemented with STB identifiers, associated parental controls and account sub-user identifiers to further indicate demographic data on a subscriber activity. Thus a particular STB in a household may have parental control and indicate use by teens. An STB in the same household without parental control would indicate adult. Account demographic data may indicate demographic data on the user, such as gender, age and education. Historical selections by a particular sub user or user of an IPTV account may also be used to characterize a user by view type and IPTV system usage (RDP application types, etc.) in addition to or instead of demographic data. It can be useful to track such view type categories of users to obtain actually viewing data rather than to use demographic data. It can also be useful to track viewer type activity and demographic activity and correlate the two to reinforce assumptions about demographic preferences. Business rules are applied to this metric to indicate subscriber activity associated with a particular household or RG.

Another example of a metric performed in the present invention on subscriber activity data is to track simultaneous DVR recording and watching usage. This metric measures the number of times consumers are watching one show and recording another. EDW parsing of the subscriber activity data enables a user to view metric values by customer or geographic region. The user can view real time, Daily, Weekly, WTD, Monthly, MTD, Quarterly, QTD, Yearly, YTD metric values. For a DVR STB that can handle a maximum of two video streams, the metric tracks use of two video streams being used at the same time for at least one minute. One stream is used for viewing, the other stream used for recording. The metric uses a standard calendar for time based aggregations. Business rules are applied to this metric to determine how many viewers are watching a live show versus recording a show. The business rule helps content providers to more realistically track content viewing and advertising viewing. Advertisements are more likely to be viewed on a live channel rather than a recorded channel as view tend to fast forward through commercials during viewing a recorded playback. Business rules allow determination of what content is being view with commercials versus played back without viewing commercials. Advertising rates and viewership ratings can be affected by time shifted viewing of recorded content.

An advertising rate for a program that is largely recorded and viewed later may be less that for a show with a smaller number of viewers that is watched live. It would be useful to know as an advertiser that one show has a viewership of 1,000,000 live viewers as opposed to a show with 2,000,000 time shifted viewers who are probably not going to watch the advertisements. It is known that time-shifted viewers generally fast forward through recorded advertisements. Thus, viewer ship numbers alone, without knowing whether viewing is live or time shifted, can be misleading to an advertiser or content provide who is setting advertising rates based on how many people may actually view an advertisement. It is live viewers, not time-shifted viewer who will probably view an advertisement, so total viewership numbers alone, with indicating live or time shifted viewing, is not a good indication of how many times an advertisement will be watched.

Another example of a metric in the present invention is channel changes. The channel changes metric measures the number of times consumers change channels during a 24-hour day. The present invention enables business rules to view channel change metric values by Customer Region (e.g., southeastern United States versus northeastern United States). The user can view real time, Daily, Weekly, WTD, Monthly, MTD, Quarterly, QTD, Yearly, and YTD metric values. Changing from channel X to channel Y generates a Channel Tune Event if the Customer was on Channel Y for at least a programmed period, for example, 20 seconds. The programmed period helps to remove rapidly flipping between channels from the metric. The Number of Channel Changes is equal to the Number of Channel Tune Events. Business rules are provided by the present invention to analyze this metric and correlate with demographic data and trends for demographic segments are correlated with the metric by rules to indicate what demographic sector (age 18-35, age 35-35, etc.) is viewing a program or advertisement without changing the channel and what demographic sector is switching channels during a program or advertisement.

A program that is viewed without switching channels can be referred to as a “sticky” program or advertisement, as the viewers displays loyalty by sticking with the program or advertisement without changing channels. Business rules can evaluate the metrics to determine what demographic is loyal to a program (doesn't change the channel, changes it an average amount for the given demographic or particular subscriber). Business rules can evaluate the metrics to determine what demographic actually views that advertisement or at least doe not change the channel during the advertisement. The business rule may indicate that the 18-35 tends to switch channels during the program, but the 35-45 group watches the program and commercial without switching channels. Channel changing activity can also be compared to trends for channel changing in different demographic sectors to indicate whether the channel changing is average, better than or worse than average.

A business rule may indicate that the program is subject to above average channel changing during a commercial or during an advertisement. A business rule may indicate that a demographic sector is loyal to the program but changes channel during the commercials. The business rule may indicate that the content provider should target advertisements to those subscribers in the loyal demographic sector. A business rule may also be applied to the channel changing activity metric to indicate whether a program is being watched in its entirety, whether the program is being watched with our without advertisements. The metric values can be grouped by the date of the Channel Tune Event. A standard calendar can be used for time based aggregations.

Another example of a metric is DVR recorded channels and shows. This metric measures the number of recordings of channels and shows executed by a subscriber. The present invention enables a user to view the metric values for DVR recorded channels and shows in real time, Daily, Weekly, WTD, Monthly, MTD, Quarterly, QTD, Yearly, YTD metric values. The present invention enables a user to view metric values by Channel and by show or program content. The user can view metric values by program content or show. Include all recordings regardless of the length of the recording. The metric includes Canceled Recordings. In VCR like recordings (user only inputs channel, start and stop time), the metric measures the Channel value. Business rules evaluate this metric to determine how many viewer and what type of viewer are watching a particular program.

A business rule can be used to determine that a younger demographic (age 18-35) loyally records Friday or Saturday night show and views it in a time-shifted recording. This may lead a content provider to broadcast a popularly recorded Friday or Saturday night show to a week night so that the 18-35 demographic sector per is home and watches the show live. Such a move may increase viewer watch of commercials as commercials are typically skipped when viewing a recorded program.

Another metric is VoD Replays, which measure the number of times VoDs (Video on Demand) are replayed. A business rule can be applied to this metric to track the number times a purchased event is replayed. The user can view metric values by Customer Region. The user can view metric values by VoD Selection in real time, daily, weekly, weekly to date (WTD), monthly, monthly to date (MTD), Quarterly, quarterly to date (QTD), Yearly, and year to date (YTD). A business rule analyzes the metric to determine when a VoD Selection is played from the beginning of the VoD Selection. The length of time of the Replay can be recorded or not. The business rule determines whether the customer has played the same VoD Selection within the last 30 calendar days or whether it is the First Play. A standard calendar can be used for time based aggregations.

Another example of a metric is Preview Generated Purchased Events. This metric Measures the number of times a VoD or pay per view (PPV) was purchased within five minutes of watching the preview. A business rule can be used to analyze this metric to determine the effectiveness of the VoD and PPV previews. Number of times a VoD or PPV was purchased within five minutes of watching the preview. The user can view metric values by Customer Region. The present invention enables the user to view Daily, Weekly, WTD, Monthly, MTD, Quarterly, QTD, Yearly, and YTD metric values. The present invention enables a user to view metric values by VoD or pay per view (PPV). A Preview Generated Purchased Events may be defined as when a user navigating via an STB to a VoD storefront (Channel 1) navigates though the movie menu, selects one or more full-screen movie previews and watches the full screen preview for at least 30 seconds.

Another metric provided by the present in invention is remote desk top protocol (RDP) Application Access Frequency and usage. This metric measures how many times consumers are accessing RDP applications. A business rule is applied to this metric to track how many times consumers are accessing RDP applications and then umber of times an RDP application was launched. The present invention enables a user to view metric values by Customer Region or by VHO. The user can view Daily, Weekly, WTD, Monthly, MTD, Quarterly, QTD, Yearly, YTD metric values. The present invention enables a user to view metric values by RDP Application. In the example of the metric, RDP Application Access are equal to a launch of an RDP application.

RDP applications include applications by or through the STB such as accessing gaming from the STB, checking voice mail, email, viewing bills online, etc. Business rules are provided to correlate RDP subscriber activity to demographic sectors. The business rule can be configured to exclude non RDP Application launches such as electronic program guide (EPG) and Web Remote DVR scheduling. Business rules are also applied to correlate RDP activity with advertising and content. For example, a business rule may be applied to this metric to determine if subscribers proceed to check a bill via an RDP application after viewing a particular associated advertisement or make a purchase after a particular advertisement.

Another metric comprises the number of RDP Applications per sitting. This metric measures how many applications consumers initiate or use per sitting. A business rule is applied to this metric to track how many apps consumers initiate/use per sitting. The business rule also generates plans for communication network changes to accommodate projected RDP usage. A business rule also uses this metric to analyze the Number of applications consumers initiated or used/Number of sittings and generates a snapshot of RDP usage (i.e. Morning Report). The present invention enables a user to view metric values by Customer Region. The user can view real time, Daily, Weekly, WTD, Monthly, MTD, Quarterly, QTD, Yearly, YTD correlation of data and metric values. In the present example, a sitting starts with the time of the first RDP application launch and ends with a STB power down event, a period of inactivity threshold reached or when an STB goes into “Stand-by” mode. The metric uses a weighted average for all aggregations and uses a standard calendar for time based aggregations.

Another example of a metric provided by the present invention is VoD DVR Recordings. A business rule is applied to this metric to measure how often VoD programs are purchased and recorded via DVR and the number of VoDs recorded on a DVR or DVRs associated with an RG with one or more STBs associated with a particular RG or subscriber account. The user can view metric values by Customer Region. A business rule can view metric values by VoD Type. A metric aggregates and determines VoD DVR recoding in real time, Daily, Weekly, WTD, Monthly, MTD, Quarterly, QTD, Yearly, YTD metric values.

Another example of a metric is scheduled DVR Recordings. This metric measures the time of day consumers schedule recordings (by day part) and from where they schedule—television/SBC web site/or WAP (Wireless Access Protocol) interface. A business rule is applied to the metric to track the time of day consumers schedule recordings (by day part) and from where they schedule—television/web site/or WAP interface. Number of Scheduled DVR Recordings. The user can view metric values by Customer Region. A business rule is applied to this metric to determine whether a program is watched live or recorded. The business rule determines what demographic sector is watching live and makes recommendations as to advertising aimed at this segment. The user can view Day Part, Daily, Weekly, WTD, Monthly, MTD, Quarterly, QTD, Yearly, YTD metric values.

Another example of a metric provided by the present invention is channel viewing time, which measures the how long a consumer remains on each channel. To track how long a consumer remains on each channel. (Total length of time)/(Number of Channels). The present invention enables a user to view metric values by user can view metric values by channel or channel type, such as by Premium Channel or by non-Premium Channel. The present invention enables a user to view metric values by Viewing time % on Premium Channel by Customer Region. The user can view metric values by Channel.

A user can view metric values by viewing time % on a Premium Channel. To help manage the capacity of the IPTV delivery system, terminal servers, etc. A business rule is provided to evaluate all RDP sessions (Total Capacity Planning RDP Session Time)/(Total RDP Sessions). The user can view metric values by Customer Region. The user can view Daily, Weekly, WTD, Monthly, MTD, Quarterly, QTD, Yearly, YTD metric values. The user can view metric values by RDP Application. The user can view the numerator and denominator value. A business rule is provided for capacity planning, where Capacity Planning RDP Session Time equals RDP Session End Time minus RDP Session Start Time. The RDP Session Start Time equals the launch of the RDP Application. RDP Session End Time equals the disconnection of the RDP Application, when the RDP session. A weighted average for these aggregations and a standard calendar for time based aggregations. Business rules are applied to the metrics including but not limited to those discussed above. The business rules are applied to the IPTV subscriber activity data metrics to determine subscriber behavior and viewing habits.

The business rules are stored along with the subscriber activity data from all VHOs and or IPTV instances in the EDW data base 112 at a central location, such as the Data Center. A processor 110 at the Data Center performs metrics on the subscriber activity data and applies the business rules to analyze the metrics. The business rules can correlate all metrics, time stamps and demographics on per channel bases based on periodic time stamps which were collected and stored in EDW database. The data sample are taken and stored in periodic segments as frequently as real time. Thus, very fine temporal data slices can be taken in the analysis of the consumer activity data. The present invention enables business rules to determine trends in fine time slices up to real time occurrences of subscriber activity over long periods of time (e.g., an hour or a year) and over hundreds of thousands of data points or subscribers and subscriber activities. The fine time resolution of the data acquisition provided by the present invention enables business rules to determine activity such as how many viewers watched an entire show, how many changed the channel after five minutes, how many changed the channel at the first commercial, etc.

The present invention also provides business rules that perform correlations between how many people watched a particular type program or application and what type of program or activity they watched next and on what channel. For example, a business rule determines how many people of a particular demographic watched a news program followed by another news program. A business rule determines how many people of a particular demographic watched a comedy, drama, historical, etc. program followed by another comedy, drama, historical, etc. program respectively. A business rule determines what program different demographic segments watched after a particular program. For example, a content provider may be interested in programming a viewer migration business rule to determine what all the viewers watching “The Apprentice” watched next. Another business rule determines the number viewers watching a show in a particular geographic region in a particular demographic segment versus the same show and demographic segment in another region.

The high data sample base enables business rules to determine trends or changes in subscriber activity on the order of one percentage point, which when dealing with millions of viewers can be significant. Prior systems had such a low sample base that a one percent change could have been a mere statistical anomaly instead of a valid indication.

The present invention also provides business rules that enable subscriber activity data to be categorized by view type to imply demographic data. A viewer profile can be accumulated to infer a particular demographic without actually collecting demographic information. This implied demographic can be associated with an account number, STB, sub account user identifier or any other identifier desired. For example, a subscriber or user that watches ESPN and uses RDP to play games might be assumed to be a teenage boy, or at least a male.

Business rules are also provided to determine whether particular programs and advertisements are well matched for presentation to the demographic segment to which they seek to appeal. Business rules can analyze metrics to determine if the targeted demographic watches the content and advertisements, watches the content but not the advertisements, etc. and makes recommendations regarding placement of targeted advertising based on the business rule analysis of the metrics. It may be that a targeted demographic likes the program but not the advertisements, thus, as indicated by switching channels when the program goes to advertisement and returning to the program after the advertisement. The business rule may then suggest a more suitable advertisement type which has successful in the targeted demographic. Business rules can determine what commercials are successful in a particular demographic by analyzing metrics on the subscriber activity data indicating that the targeted demographic did not change the channel during the particular type of advertisement.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for processing subscriber activity data from a plurality of internet protocol television (IPTV) systems comprising:
recording subscriber activity data in real time;
transmitting the recorded subscriber activity data to one of the plurality of IPTV systems;
aggregating the recorded subscriber activity data from the one of the plurality of IPTV systems;
parsing the aggregated subscriber activity data into subscriber activity event data events;
and
storing the aggregated subscriber activity data events in a data base.

2. The method of claim 1, further comprising:
collecting the recorded subscriber activity data in a load-ready data format from the one of the plurality of IPTV systems.

3. The method of claim 1, wherein the events comprise at least one member selected from a set consisting of: channel tune, set top box power up/down, video on demand purchase, trick mode, digital video recorder (DVR) record and DVR delete.

4. The method of claim 1, further comprising:
performing a metric on at least one of the events.

5. The method of claim 4, wherein the metric comprises at least one member selected from a set consisting of viewing usage, simultaneous DVR recording and watching usage, channel changes, recorded channels and show, VOD replay, preview generated purchased events, remote desktop protocol applications per sitting, VOD DVR recordings, scheduled DVR recordings, channel viewing time and average RDP time.

6. The method of claim 4, further comprising:
applying a business rule to at least one of the metrics.

7. The method of claim 6, wherein the business rule further comprises correlating subscriber activity related to viewing of content and advertising with at least one member selected from a set consisting of demographic sector, time slot and geographic region.

8. A computer readable medium containing instructions that when executed by a computer method for processing subscriber activity data from a plurality of internet protocol television (IPTV) system comprising:
recording subscriber activity data in real time;
transmitting the recorded subscriber activity data to one of the plurality of IPTV systems;
aggregating the recorded subscriber activity data from the one of the plurality of IPTV systems;
parsing the aggregated subscriber activity data into subscriber activity event data events;
and
storing the aggregated subscriber activity data events in a data base.

9. The medium of claim 8, wherein the method further comprises:
collecting the recorded subscriber activity data in a load-ready data format from the one of the plurality of IPTV systems.

10. The medium of claim 8, wherein in the method the events comprise at least one member selected from a set consisting of channel tune, set top box power up/down, video on demand purchase, trick mode, digital video recorder (DVR) record and DVR delete.

11. The medium of claim 8, wherein the method further comprises:
performing a metric on at least one of the events.

12. The medium of claim 11, wherein in the method the metric comprises at least one selected from a set consisting of viewing usage, simultaneous DVR recording and watching usage, channel changes, recorded channels and show, VOD replay, preview generated purchased events, remote desktop protocol applications per sitting, VOD DVR recordings, scheduled DVR recordings, channel viewing time and average RDP time.

13. The medium of claim 11, further comprising:
applying a business rule to at least one of the metrics.

14. The medium of claim 13, wherein in the method the business rule further comprises correlating subscriber's activity indicating viewing of content and advertising with at least one member selected from a set consisting of demographic sector, time slot and geographic region.

15. A system for processing subscriber activity data from a plurality of internet protocol television (IPTV) systems comprising:
a set top box (STB) in communication with a subscriber remote control for interacting with the IPTV system;
a recorder associated with the set top box;
an STB processor associated with the STB configured to record subscriber activity data from the remote control in real time and transmit the recorded subscriber activity data to one of the plurality of IPTV systems; and
a central processor configured to aggregate the recorded subscriber activity data from the one of the plurality of IPTV systems, parse the aggregated subscriber activity data into subscriber activity data events and store the parsed subscriber activity data events in a data base.

16. The system of claim 15, wherein the central processor is further configured to collect the subscriber activity data in a load-ready data format.

17. The system of claim 15, wherein the events comprise at least one member selected from a set consisting of channel tune, set top box power up/down, video on demand purchase, trick mode, digital video recorder (DVR) record and DVR delete.

18. The system of claim 15, wherein the central processor is further configured to perform a metric on at least one of the events.

19. The system of claim 18, wherein the metric comprises at least one member selected from a set consisting of viewing usage, simultaneous DVR recording and watching usage, channel changes, recorded channels and show, VOD replay, preview generated purchased events, remote desktop protocol applications per sitting, VOD DVR recordings, scheduled DVR recordings, channel viewing time and average RDP time.

20. The system of claim 18, further comprising:
a business rule in memory wherein the central processor is further configured to apply the business rule to at least one of the metrics.

21. The system of claim 20, wherein the business rule further comprises correlating subscriber activity related to viewing of content and advertising with at least one member selected from asset consisting of demographic sector, time slot and geographic region.
